(19) United States
(12) Patent Application Publication
(10) Pub. No.: US 2026/0025868 A1
(43) Pub. Date: Jan. 22, 2026

(54) METHOD FOR ENERGY EFFICIENT SPECTRUM SHARING

(71) Applicant: Nokia Technologies Oy, Espoo (FI)

(72) Inventor: Navin HATHIRAMANI, Dallas, TX (US)

(21) Appl. No.: 18/869,267

(22) PCT Filed: May 31, 2022
(86) PCT No.: PCT/EP2022/064723

§ 371 Date: Nov. 25, 2024

(51) Int. Cl. H04W 76/15; H04W 16/14; H04W 36/00; H04W 74/0833; H04W 76/20

(52) U.S. Cl. CPC H04W 76/15; H04W 16/14; H04W 36/0058; H04W 36/008357; H04W 74/0833; H04W 76/20

(57) ABSTRACT

An apparatus comprising: means for providing a first cell being a dynamic spectrum sharing cell supporting at least a first radio access technology, wherein at least one random access preamble indicating a request to be redirected to a second cell supporting at least a second radio access technology is stored in the apparatus: means for transmitting signaling information to at least one user equipment via the first radio access technology, wherein said signaling information comprises information for establishing a connection to the second cell: means for receiving a random access preamble from at least one user equipment via the first radio access technology, said random access preamble indicating a request for the user equipment to be redirected to the second cell supporting at least the second radio access technology: means for transmitting an indication to the second cell to transition to an active state; and means for transmitting a random access preamble response to the user equipment via the first radio access technology, wherein the random access preamble response comprises signaling for re-directing the user equipment to camp on a second cell supporting at least the second radio access technology.

### TECHNICAL FIELD

The present invention relates to spectrum sharing procedures.

### BACKGROUND

Throughout the history of 3GPP networks, there has been an ongoing migration towards a next generation radio access technology (RAT). This poses challenges to network operators regarding their decisions about when and to what extent to invest on the next generation RAT. Dynamic Spectrum Sharing (DSS) was introduced in 3GPP Release 15 to provide a migration path from 4G/LTE (4th Generation/Long-Term Evolution) to 5G/NR (5th Generation/New Radio) by allowing LTE and NR to share the same carrier.

In the initial stages of deploying a new RAT, such as 5G/NR, DSS is typically deployed on low frequency bands to be able to extend the new RAT coverage. For example, when 5G/NR user equipment (UE) market penetration is low, i.e. most users are employing 4G/LTE devices, the activation of 5G on a cell should introduce minimum overhead.

However, in 4G-5G DSS, the 5G DSS Cell must continuously transmit downlink signals (such as synchronization and system information signals and messages) without knowledge of any 5G-capable UEs in its area, which inevitably reduces the available radio resource capacity for the 4G/LTE connections. Although there are typically only few or even no 5G-capable UEs present, the 5G DSS Cell provides constant overhead in the DSS cell. This decreases the perceived performance of the 4G/LTE UEs and creates additional power consumption due to DL transmission.

### SUMMARY

Now, improved methods and technical equipment implementing the methods have been invented, by which the above problems are alleviated. Various aspects include a method, an apparatus and a non-transitory computer readable medium comprising a computer program, or a signal stored therein, which are characterized by what is stated in the independent claims.

Various details of the embodiments are disclosed in the dependent claims and in the corresponding images and description.

The scope of protection sought for various embodiments of the invention is set out by the independent claims. The embodiments and features, if any, described in this specification that do not fall under the scope of the independent claims are to be interpreted as examples useful for understanding various embodiments of the invention.

According to a first aspect, there is provided an apparatus comprising means for establishing a connection to a cell using a first radio access technology and a second radio access technology; means for camping on a first cell using at least the first radio access technology in an idle mode of radio resource control (RRC) protocol of the first radio access technology; means for identifying, in response to receiving signaling information from the first cell, said first cell as a dynamic spectrum sharing cell, wherein spectrum sharing provides support for a second cell supporting the second radio access technology and said signaling information comprises information for establishing a connection to the second cell; means for transmitting a random access preamble to the first cell, said random access preamble indicating a request to be redirected to the second cell supporting the second radio access technology; means for receiving a random access preamble response from the first cell; means for redirecting, based on the random access preamble response, to the second cell supporting the second radio access technology; and means for carrying out signaling for transition the apparatus into a connected mode of the radio resource control (RRC) protocol of the second radio access technology.

According to an embodiment, the random access preamble is a random access preamble dedicated to the second cell supporting the second radio access technology.

According to an embodiment, the apparatus comprises means for performing downlink coarse time and frequency tracking for the second cell based on signals of the first cell.

According to an embodiment, the apparatus comprises means for transitioning from the connected mode to the idle mode; means for performing measurements for the second cell; and means, responsive to detecting that the second cell is out of coverage, for re-directing the connection to the first cell.

According to an embodiment, the apparatus comprises means for performing inter-radio access technology measurements among a plurality of cells supporting at least the first and the second radio access technology; means for detecting a need for a handover; and means, responsive to detecting that a target cell of the handover supporting the second radio access technology is in an inactive state, for re-directing the connection to a dynamic spectrum sharing cell corresponding to said target cell and using said measurements on the first radio access technology.

According to an embodiment, the apparatus comprises means, responsive to identifying said cell as a dynamic spectrum sharing cell, for displaying a first indication on a display of the apparatus, said first indication indicating that a connection to the second cell supporting at least the second radio access technology is available.

According to an embodiment, the apparatus comprises means, responsive to entering the second cell in a connected mode, for displaying a second indication on the display of the apparatus, said second indication indicating that a connection to the second cell supporting at least the second radio access technology has been established.

According to an embodiment, said signaling information comprises information on service-based usage of the random access preambles associated with the first radio access technology and the second radio access technology.

According to an embodiment, the apparatus comprises means for selecting a preamble from the first or the second radio access technology based on a type of service that is being initiated.

According to an embodiment, the random access preamble response comprises timing advance information and downlink timing received from the first cell using the first radio access technology, the apparatus comprising means for employing the timing advance information and the downlink timing of the first cell using the first radio access technology to synchronize downlink and uplink of the second cell using the second radio access technology.

According to an embodiment, the apparatus comprises means for obtaining non-essential system information after redirecting to the second cell using the second radio access technology.

A second aspect relates to a method comprising: camping, by an apparatus comprising means for establishing a connection to a cell using a first radio access technology and a second radio access technology, on a first cell using at least the first radio access technology in an idle mode of radio resource control (RRC) protocol of the first radio access technology; identifying, in response to receiving signaling information from the first cell, said first cell as a dynamic spectrum sharing cell, wherein spectrum sharing provides support for a second cell supporting the second radio access technology and said signaling information comprises information for establishing a connection to the second cell; transmitting a random access preamble to the first cell, said random access preamble indicating a request to be redirected to the second cell supporting the second radio access technology; receiving a random access preamble response from the first cell; redirecting, based on the random access preamble response, to the second cell supporting the second radio access technology; and carrying out signaling for transition the apparatus into a connected mode of the radio resource control (RRC) protocol of the second radio access technology.

An apparatus according to a third aspect comprises at least one processor and at least one memory, said at least one memory stored with computer program code thereon, the at least one memory and the computer program code configured to, with the at least one processor, cause the apparatus at least to perform: camp on a first cell using at least the first radio access technology in an idle mode of radio resource control (RRC) protocol of the first radio access technology; identify, in response to receiving signaling information from the first cell, said first cell as a dynamic spectrum sharing cell, wherein spectrum sharing provides support for a second cell supporting the second radio access technology and said signaling information comprises information for establishing a connection to the second cell; transmit a random access preamble to the first cell, said random access preamble indicating a request to be redirected to the second cell supporting the second radio access technology; receive a random access preamble response from the first cell; redirect, based on the random access preamble response, to the second cell supporting the second radio access technology; and carry out signaling for transition the apparatus into a connected mode of the radio resource control (RRC) protocol of the second radio access technology.

An apparatus according to a fourth aspect comprises means for providing a first cell being a dynamic spectrum sharing cell supporting at least a first radio access technology, wherein at least one random access preamble indicating a request to be redirected to a second cell supporting at least a second radio access technology is stored in the apparatus; means for transmitting signaling information to at least one user equipment via the first radio access technology, wherein said signaling information comprises information for establishing a connection to the second cell; means for receiving a random access preamble from at least one user equipment via the first radio access technology, said random access preamble indicating a request for the user equipment to be redirected to the second cell supporting at least the second radio access technology; means for transmitting an indication to the second cell to transition to an active state; and means for transmitting a random access preamble response to the user equipment via the first radio access technology, wherein the random access preamble response comprises signaling for re-directing the user equipment to camp on a second cell supporting at least the second radio access technology.

According to an embodiment, the random access preamble is a random access preamble dedicated to the second cell supporting the second radio access technology.

According to an embodiment, the apparatus comprises means comprises means for including in the random access preamble response (RAR) message one or more of the following:
information for re-directing the user equipment to the second cell;
assistance information on uplink timing information to the second cell for the user equipment;
assistance information on downlink timing;
information on aperiodic or periodic signal for fine tuning of a frequency/time of the second cell;
information on a beam of the second cell relative to a beam of the first cell;
a grant for uplink transmission in the second cell.

According to an embodiment, said signaling information comprises information on service-based usage of the random access preambles associated with the first radio access technology and the second radio access technology.

According to an embodiment, the apparatus comprises means for configuring the user equipment to perform inter-radio access technology measurements for an intra-radio access technology handover of a target dynamic spectrum sharing cell in which the second radio access technology is inactive.

A method according to a fifth aspect comprises: providing a first cell being a dynamic spectrum sharing cell supporting at least a first radio access technology, wherein at least one random access preamble indicating a request to be redirected to a second cell supporting at least a second radio access technology is stored in an apparatus providing the first cell; transmitting signaling information to at least one user equipment via the first radio access technology, wherein said signaling information comprises information for establishing a connection to the second cell; receiving a random access preamble from at least one user equipment via the first radio access technology, said random access preamble indicating a request for the user equipment to be redirected to the second cell supporting at least the second radio access technology; transmitting an indication to the second cell to transition to an active state; and transmitting a random access preamble response to the user equipment via the first radio access technology, wherein the random access preamble response comprises signaling for re-directing the user equipment to camp on the second cell supporting at least the second radio access technology.

An apparatus according to a sixth aspect comprises at least one processor and at least one memory, said at least one memory stored with computer program code thereon, the at least one memory and the computer program code configured to, with the at least one processor, cause the apparatus at least to perform: provide a first cell being a dynamic spectrum sharing cell supporting at least a first radio access technology, wherein at least one random access preamble indicating a request to be redirected to a second cell supporting at least a second radio access technology is stored in the apparatus; transmit signaling information to at least one user equipment via the first radio access technology, wherein said signaling information comprises information for establishing a connection to the second cell; receive a random access preamble from at least one user equipment via the first radio access technology, said random access preamble indicating a request for the user equipment to be redirected to the second cell supporting at least the second radio access technology; transmit an indication to the second cell to transition to an active state; and transmit a random access preamble response to the user equipment via the first radio access technology, wherein the random access preamble response comprises signaling for re-directing the user equipment to camp on a second cell supporting at least the second radio access technology.

An apparatus according to a seventh aspect comprises means for providing a second cell being a dynamic spectrum sharing cell supporting at least a second radio access technology, wherein at least one random access preamble for said apparatus in a first cell providing a dynamic spectrum sharing cell supporting at least a first radio access technology indicates a request for a user equipment to be redirected; means for configuring the apparatus to operate in an inactive state; means for receiving an indication from the first cell to transition to an active state, said indication being triggered by a random access preamble received by the first cell from at least one user equipment via the first radio access technology, said random access preamble indicating a request for the user equipment to be redirected to the second cell supporting at least the second radio access technology; and means for carrying out signaling for transition the user equipment into a connected mode of the radio resource control (RRC) protocol of the second radio access technology.

According to an embodiment, the random access preamble is a random access preamble dedicated to the second cell supporting the second radio access technology.

According to an embodiment, the apparatus comprises means for transmitting downlink broadcast and control information to the user equipment in the active state.

According to an embodiment, the apparatus comprises means for initiating a timer when the number of the user equipment in the connected mode of the RRC protocol is zero; and means for configuring the apparatus to transition to an inactive state upon expiry of the timer.

According to an embodiment, the apparatus comprises means for ceasing to transmit downlink broadcast and control information to the user equipment in the active state.

According to an embodiment, the apparatus comprises means for informing the a core network of the transition to the inactive state.

According to an embodiment, the apparatus comprises means for informing other cells using the second radio access technology about the transition to the inactive state.

A method according to an eighth aspect comprises providing, by a network element, a second cell being a dynamic spectrum sharing cell supporting at least a second radio access technology, wherein at least one random access preamble for said network element in a first cell providing a dynamic spectrum sharing cell supporting at least a first radio access technology indicates a request for a user equipment to be redirected; configuring the network element to operate in an inactive state; receiving an indication from the first cell to transition to an active state, said indication being triggered by a random access preamble received by the first cell from at least one user equipment via the first radio access technology, said random access preamble indicating a request for the user equipment to be redirected to the second cell supporting at least the second radio access technology; and carrying out signaling for transition the user equipment into a connected mode of the radio resource control (RRC) protocol of the second radio access technology.

An apparatus according to a ninth aspect comprises at least one processor and at least one memory, said at least one memory stored with computer program code thereon, the at least one memory and the computer program code configured to, with the at least one processor, cause the apparatus at least to perform: provide a second cell being a dynamic spectrum sharing cell supporting at least a second radio access technology, wherein at least one random access preamble for said apparatus in a first cell providing a dynamic spectrum sharing cell supporting at least a first radio access technology indicates a request for a user equipment to be redirected; configure the apparatus to operate in an inactive state; receive an indication from the first cell to transition to an active state, said indication being triggered by a random access preamble received by the first cell from at least one user equipment via the first radio access technology, said random access preamble indicating a request for the user equipment to be redirected to the second cell supporting at least the second radio access technology; and carry out signaling for transition the user equipment into a connected mode of the radio resource control (RRC) protocol of the second radio access technology.

Computer readable storage media according to further aspects comprise code for use by an apparatus, which when executed by a processor, causes the apparatus to perform the above methods.

### BRIEF DESCRIPTION OF THE DRAWINGS

For a more complete understanding of the example embodiments, reference is now made to the following descriptions taken in connection with the accompanying drawings in which:

FIG. 1 shows a schematic block diagram of an apparatus for incorporating a beam distribution arrangement according to the embodiments;

FIG. 2 shows schematically a layout of an apparatus according to an example embodiment;

FIG. 3 shows a part of an exemplifying radio access network;

FIG. 4 shows an example of a 4G-5G dynamic spectrum sharing (DSS) procedure;

FIG. 5 shows a flow chart for a DSS procedure carried out by a user equipment according to an embodiment;

FIG. 6 shows a flow chart for a DSS procedure carried out by an access point according to an embodiment;

FIG. 7 shows a signalling chart for a DSS procedure according to various embodiments;

FIG. 8 shows a flow chart for a DSS procedure carried out by an access point according to another embodiment;

FIG. 9 shows a flow chart for a DSS procedure carried out by a 5G DSS Cell according to various embodiments;

FIG. 10 shows a flow chart for a DSS procedure carried out by a 6G DSS Cell according to various embodiments; and

FIG. 11 shows a flow chart for a DSS procedure carried out by a 6G UE according to various embodiments.

### DETAILED DESCRIPTION OF SOME EXAMPLE EMBODIMENTS

The following describes in further detail suitable apparatus and possible mechanisms supplementing the Dynamic Spectrum Sharing (DSS) procedures. While the following focuses on 4G, 5G and 6G networks, the embodiments as described further below are by no means limited to be implemented in said networks only, but they are applicable in any network supporting DSS.

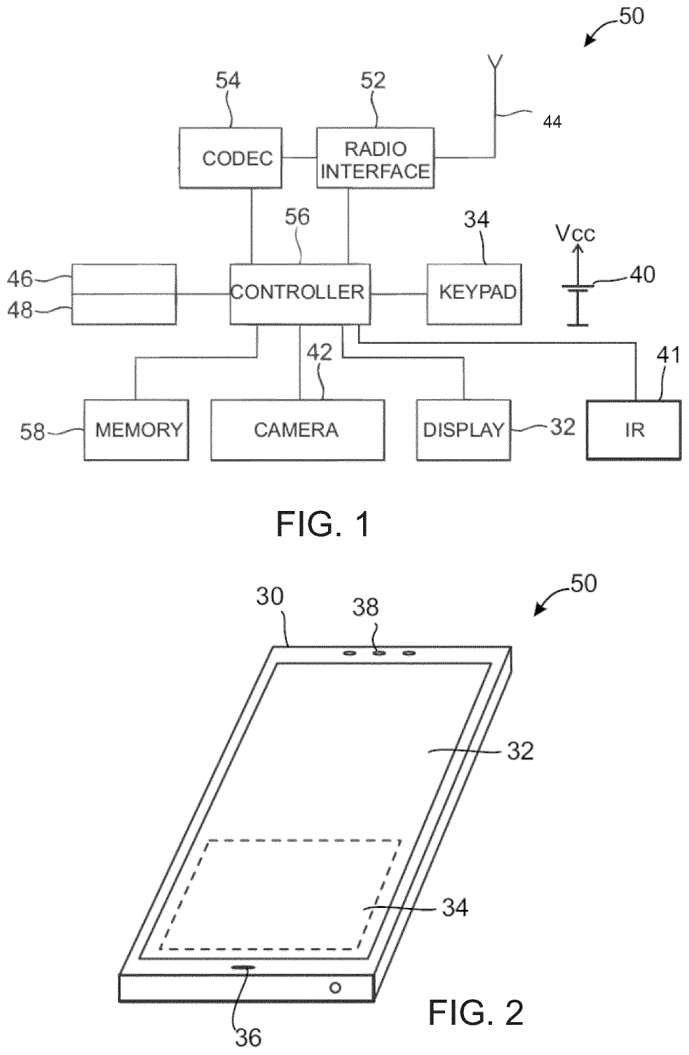

In this regard, reference is first made to FIGS. 1 and 2, where FIG. 1 shows a schematic block diagram of an exemplary apparatus or electronic device 50, which may incorporate the arrangement according to the embodiments. FIG. 2 shows a layout of an apparatus according to an example embodiment. The elements of FIGS. 1 and 2 will be explained next.

The electronic device 50 may for example be a mobile terminal or user equipment of a wireless communication system. The apparatus 50 may comprise a housing 30 for incorporating and protecting the device. The apparatus 50 further may comprise a display 32 and a keypad 34. Instead of the keypad, the user interface may be implemented as a virtual keyboard or data entry system as part of a touch-sensitive display.

The apparatus may comprise a microphone 36 or any suitable audio input which may be a digital or analogue signal input. The apparatus 50 may further comprise an audio output device, such as anyone of: an earpiece 38, speaker, or an analogue audio or digital audio output connection. The apparatus 50 may also comprise a battery 40 (or the device may be powered by any suitable mobile energy device such as solar cell, fuel cell or clockwork generator). The apparatus may further comprise a camera 42 capable of recording or capturing images and/or video. The apparatus 50 may further comprise an infrared port 41 for short range line of sight communication to other devices. In other embodiments the apparatus 50 may further comprise any suitable short-range communication solution such as for example a Bluetooth wireless connection or a USB/firewire wired connection.

The apparatus 50 may comprise a controller 56 or processor for controlling the apparatus 50. The controller 56 may be connected to memory 58 which may store both user data and instructions for implementation on the controller 56. The memory may be random access memory (RAM) and/or read only memory (ROM). The memory may store computer-readable, computer-executable software including instructions that, when executed, cause the controller/processor to perform various functions described herein. In some cases, the software may not be directly executable by the processor but may cause a computer (e.g., when compiled and executed) to perform functions described herein. The controller 56 may further be connected to codec circuitry 54 suitable for carrying out coding and decoding of audio and/or video data or assisting in coding and decoding carried out by the controller.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

In the following, different exemplifying embodiments will be described using, as an example of an access architecture to which the embodiments may be applied, a radio access technology (RAT) based on Long Term Evolution Advanced (LTE Advanced, LTE-A) or new radio (NR, 5G), without restricting the embodiments to such an architecture, however. A person skilled in the art appreciates that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet protocol multimedia subsystems (IMS) or any combination thereof.

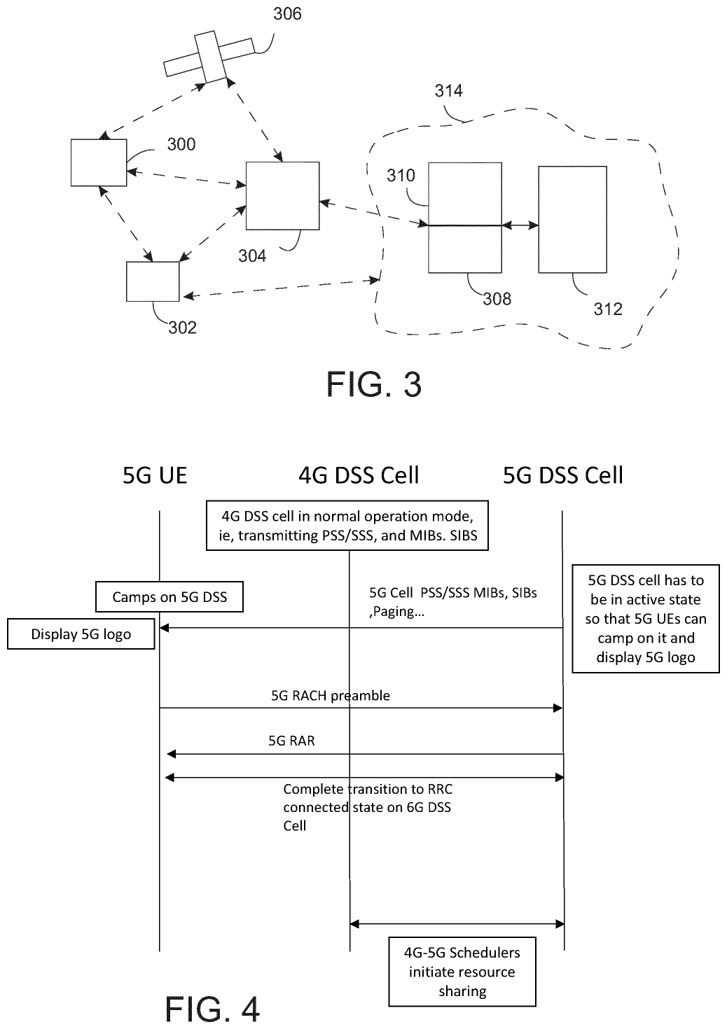

FIG. 3 depicts examples of simplified system architectures only showing some elements and functional entities, all being logical units, whose implementation may differ from what is shown. The connections shown in FIG. 3 are logical connections; the actual physical connections may be different. It is apparent to a person skilled in the art that the system typically comprises also other functions and structures than those shown in FIG. 3. The embodiments are not, however, restricted to the system given as an example but a person skilled in the art may apply the solution to other communication systems provided with necessary properties.

The example of FIG. 3 shows a part of an exemplifying radio access network.

FIG. 3 shows user devices 300 and 302 configured to be in a wireless connection on one or more communication channels in a cell with an access node (such as (e/g) NodeB) 304 providing the cell. The physical link from a user device to a (e/g) NodeB is called uplink or reverse link and the physical link from the (e/g) NodeB to the user device is called downlink or forward link. It should be appreciated that (e/g) NodeBs or their functionalities may be implemented by using any node, host, server or access point etc. entity suitable for such a usage.

A communication system typically comprises more than one (e/g) NodeB in which case the (e/g) NodeBs may also be configured to communicate with one another over links, wired or wireless, designed for the purpose. These links may be used for signaling purposes. The (e/g) NodeB is a computing device configured to control the radio resources of communication system it is coupled to. The NodeB may also be referred to as a base station, an access point or any other type of interfacing device including a relay station capable of operating in a wireless environment. The (e/g) NodeB includes or is coupled to transceivers. From the transceivers of the (e/g) NodeB, a connection is provided to an antenna unit that establishes bi-directional radio links to user devices. The antenna unit may comprise a plurality of antennas or antenna elements. The (e/g) NodeB is further connected to core network 310 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc. The CN may comprise network entities or nodes that may be referred to management entities. Examples of the network entities comprise at least an Access and Mobility Management Function (AMF).

The user device (also called a user equipment (UE), a user terminal, a terminal device, a wireless device, a mobile station (MS) etc.) illustrates one type of an apparatus to which resources on the air interface are allocated and assigned, and thus any feature described herein with a user device may be implemented with a corresponding network apparatus, such as a relay node, an eNB, and an gNB. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. Accordingly, the user device may be an IoT-device. The user device may also utilize cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. The access nodes of the radio network form transmission/reception (TX/Rx) points (TRPs), and the UEs are expected to access networks of at least partly overlapping multi-TRPs, such as macro-cells, small cells, pico-cells, femto-cells, remote radio heads, relay nodes, etc. The access nodes may be provided with Massive MIMO antennas, i.e. very large antenna array consisting of e.g. hundreds of antenna elements, implemented in a single antenna panel or in a plurality of antenna panels, capable of using a plurality of simultaneous radio beams for communication with the UE. The UEs may be provided with MIMO antennas having an antenna array consisting of e.g. dozens of antenna elements, implemented in a single antenna panel or in a plurality of antenna panels. Thus, the UE may access one TRP using one beam, one TRP using a plurality of beams, a plurality of TRPs using one (common) beam or a plurality of TRPs using a plurality of beams.

The 4G/LTE networks support some multi-TRP schemes, but in 5G NR the multi-TRP features are enhanced e.g. via transmission of multiple control signals via multi-TRPs, which enables to improve link diversity gain. Moreover, high carrier frequencies (e.g., mmWaves) together with the Massive MIMO antennas require new beam management procedures for multi-TRP technology.

5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also capable of being integrated with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

Frequency bands for 5G NR are separated into two frequency ranges: Frequency Range 1 (FR1) including sub-6 GHz frequency bands, i.e. bands traditionally used by previous standards, but also new bands extended to cover potential new spectrum offerings from 410 MHz to 7125 MHz, and Frequency Range 2 (FR2) including frequency bands from 24.25 GHz to 52.6 GHz. Thus, FR2 includes the bands in the mmWave range, which due to their shorter range and higher available bandwidth require somewhat different approach in radio resource management compared to bands in the FR1.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 312, or utilize services provided by them. The communication network may also be able to support the usage of cloud services, for example at least part of core network operations may be carried out as a cloud service (this is depicted in FIG. 3 by “cloud” 314). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU) and non-real time functions being carried out in a centralized manner (in a centralized unit, CU 308).

It should also be understood that the distribution of labor between core network operations and base station operations may differ from that of the LTE or even be non-existent.

Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well. The gNB is a next generation Node B (or, new Node B) supporting the 5G network (i.e., the NR).

5G may also utilize non-terrestrial nodes 306, e.g. access nodes, to enhance or complement the coverage of 5G service, for example by providing backhauling, wireless access to wireless devices, service continuity for machine-to-machine (M2M) communication, service continuity for Internet of Things (IoT) devices, service continuity for passengers on board of vehicles, ensuring service availability for critical communications and/or ensuring service availability for future railway/maritime/aeronautical communications. The non-terrestrial nodes may have fixed positions with respect to the Earth surface or the non-terrestrial nodes may be mobile non-terrestrial nodes that may move with respect to the Earth surface. The non-terrestrial nodes may comprise satellites and/or HAPSs. Satellite communication may utilize geostationary earth orbit (GEO) satellite systems, but also low earth orbit (LEO) satellite systems, in particular mega-constellations (systems in which hundreds of (nano) satellites are deployed). Each satellite in the mega-constellation may cover several satellite-enabled network entities that create on-ground cells. The on-ground cells may be created through an on-ground relay node 304 or by a gNB located on-ground or in a satellite.

A person skilled in the art appreciates that the depicted system is only an example of a part of a radio access system and in practice, the system may comprise a plurality of (e/g) NodeBs, the user device may have an access to a plurality of radio cells and the system may comprise also other apparatuses, such as physical layer relay nodes or other network elements, etc. At least one of the (e/g) NodeBs or may be a Home (e/g) nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto-or picocells. The (e/g) NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g) NodeBs are required to provide such a network structure.

For fulfilling the need for improving the deployment and performance of communication systems, the concept of “plug-and-play” (e/g) NodeBs has been introduced. Typically, a network which is able to use “plug-and-play” (e/g) Node Bs, includes, in addition to Home (e/g) NodeBs (H (e/g) nodeBs), a home node B gateway, or HNB-GW (not shown in FIG. 1). A HNB Gateway (HNB-GW), which is typically installed within an operator's network may aggregate traffic from a large number of HNBs back to a core network.

The Radio Resource Control (RRC) protocol is used in various wireless communication systems for defining the air interface between the UE and a base station, such as eNB/gNB. This protocol is specified by 3GPP in in TS 36.331 for LTE and in TS 38.331 for 5G. In terms of the RRC, the UE may operate in LTE and in 5G in an idle mode or in a connected mode, wherein the radio resources available for the UE are dependent on the mode where the UE at present resides. In 5G, the UE may also operate in inactive mode. In the RRC idle mode, the UE has no connection for communication, but the UE is able to listen to page messages. The UE may communicate with the eNB/gNB via various logical channels like Broadcast Control Channel (BCCH), Paging Control Channel (PCCH), Common Control Channel (CCCH), Dedicated Control Channel (DCCH), Dedicated Traffic Channel (DTCH).

The transitions between the states are controlled by a state machine of the RRC. When the UE is powered up, it is in a disconnected mode/idle mode. The UE may transit to RRC connected mode with an initial attach or with a connection establishment. If there is no activity from the UE for a short time, eNB/gNB may suspend its session by moving to RRC Inactive and can resume its session by moving to RRC connected mode. The UE can move to the RRC idle mode from the RRC connected mode or from the RRC inactive mode.

The actual user and control data from network to the UEs is transmitted via downlink physical channels, which in 5G include Physical downlink control channel (PDCCH) which carries the necessary downlink control information (DCI), Physical Downlink Shared Channel (PDSCH), which carries the user data and system information for user, and Physical broadcast channel (PBCH), which carries the necessary system information to enable a UE to access the 5G network.

The user and control data from UE to the network is transmitted via uplink physical channels, which in 5G include Physical Uplink Control Channel (PUCCH), which is used for uplink control information including HARQ feedback acknowledgments, scheduling request, and downlink channel-state information for link adaptation, Physical Uplink Shared Channel (PUSCH), which is used for uplink data transmission, and Physical Random Access Channel (PRACH), which is used by the UE to request connection setup referred to as random access.

Throughout the history of 3GPP networks, there has been an ongoing migration towards a next generation radio access technology (RAT). This poses challenges to network operators regarding their decisions about when and to what extent to invest on the next generation RAT. Dynamic Spectrum Sharing (DSS) was introduced in 3GPP Release 15 to provide a migration path from LTE to NR by allowing LTE and NR to share the same carrier. Thus, DSS allows for progressive resource (i.e. frequency) dedication to NR, as NR device market penetration increases.

In the initial stages of deploying a new RAT, network operators tend to prioritize the coverage of the new RAT at least for advertising and marketing purposes. For example, the operators are deploying LTE-NR DSS initially on low frequency bands to be able to claim an extended 5G coverage. These low frequency bands may be used as fallback bands for NR devices due to coverage challenges in other bands and most operators have limited low band spectrum, possibly not enough to have separate resources for LTE and NR. The DSS was introduced to tackle at least this problem.

When NR UE market penetration is low, it means that most users are employing LTE devices, and hence, the activation of 5G on a cell should introduce minimum overheads. As NR UE penetration rate increases, more capacity will be required for them, and hence, an efficient sharing mechanism will be required for 4G-5G sharing in these low bands.

FIG. 4 shows an example of LTE-NR DSS procedure. In the beginning, a 4G cell provided with dynamic spectrum sharing (DSS) capabilities, i.e. a 4G DSS Cell, is in a normal operating mode, where 4G Primary and Secondary Synchronization Signals (PSS/SSS) are broadcasted, as well as various Master Information Blocks (MIBs) and System Information Blocks (SIBs).

At least partly the same geographical area as covered by the 4G DSS Cell may also be covered by a 5G DSS Cell. The 5G resources of the 5G DSS Cell may be provided by the same or at least partly different NBs as used for the 4G DSS Cell. In a typical DSS scenario, the 4G and 5G resources are provided by common radio units. The same, or alternatively different, baseband units may be used for the 4G and 5G resources.

The 5G-capable UE may initially camp on the 5G DSS Cell. For the purpose of any 5G-capable UE to be able to camp on the 5G DSS Cell in RRC Idle mode, the 5G DSS Cell has to be in an active state, meaning that the one or more cells periodically broadcast Synchronization Signals (PSS/SSS), MIBs, SIBs, various paging messages, etc. The 5G DSS Cell reserves some RACH preamble resources for 5G UEs and broadcasts them to the UEs. Based on the 5G DSS Cell broadcast information, the UE identifies the cell as a 5G DSS cell. The UE may display a 5G icon or any other kind of indication, showing to the user that 5G connections are possible in this cell.

The UE then carries out RRC establishment procedure by transmitting at least one of the RACH preambles to the 5G DSS Cell, which response by a RACH preamble response (RAR) message, after which the transition to the RRC connected mode can be completed. Thereafter, the 4G and 5G schedulers may initiate resource sharing beyond the default originally reserved resources for each radio access technology.

However, the fact that the 5G DSS Cell must continuously transmit downlink (DL) signals (including synchronization, SIBs and MIBs) without any 5G-capable UEs in its area inevitably reduces the available radio resource capacity for the 4G connections. Especially during the early stages of 5G deployment, there are typically only few or even no 5G-capable UEs present. Nevertheless, the 5G DSS Cell provides constant overhead in the DSS cell even if there are no 5G-capable UEs present. This decreases the perceived performance of the 4G UEs and creates additional power consumption due to DL transmission.

Accordingly, there is a need for a method for via which a legacy RAT can operate with minimal overheads and yet enable the cell to be used in DSS mode in the presence of new RAT users.

In the following, an enhanced method to enable more spectrally and energy efficient usage of the spectrum resources for DSS will be described in more detail, in accordance with various embodiments.

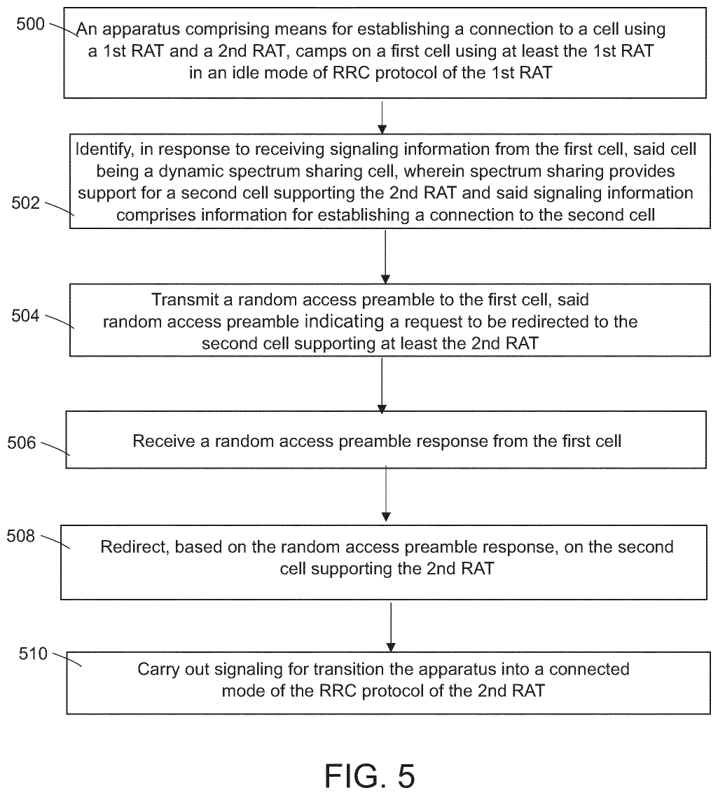

The method, which is disclosed in the flow chart of FIG. 5 as reflecting the operation of a terminal apparatus, such as a user equipment (UE), wherein the apparatus comprises means for establishing a connection to a cell using a first radio access technology and a second radio access technology; wherein the method comprises camping (500) on a first cell using at least the first radio access technology in an idle mode of radio resource control (RRC) protocol of the first radio access technology; identifying (502), in response to receiving signaling information from the first cell, said first cell as a dynamic spectrum sharing cell, wherein spectrum sharing provides support for a second cell supporting the second radio access technology and said signaling information comprises information for establishing a connection to the second cell; transmitting (504) a random access preamble to the first cell, said random access preamble indicating a request to be redirected to the second cell supporting at least the second radio access technology; receiving (506) a random access preamble response from the first cell; redirecting (508), based on the random access preamble response, to the second cell supporting the second radio access technology; and carrying out (510) signaling for transition the apparatus into a connected mode of the radio resource control (RRC) protocol of the second radio access technology.

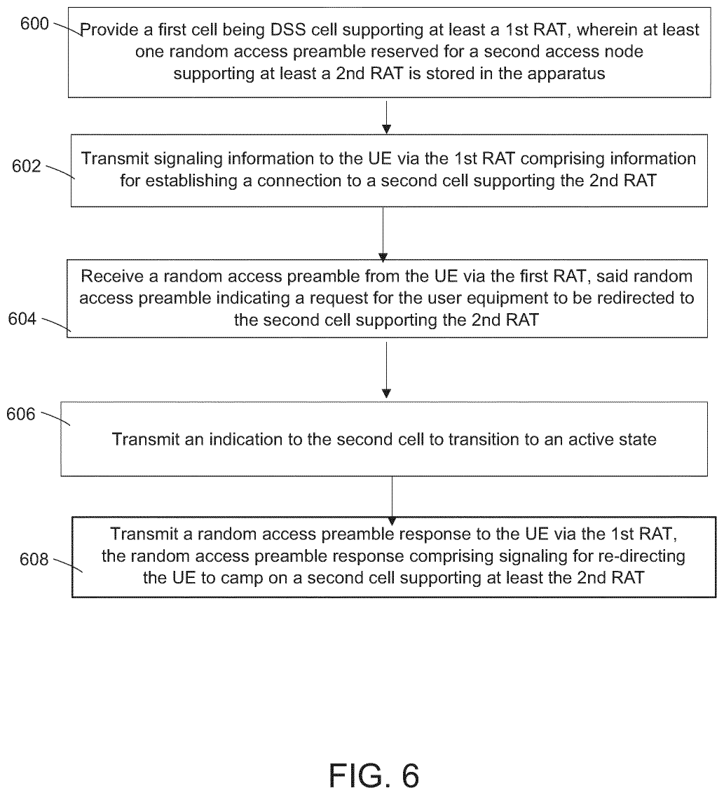

The method may also be illustrated as reflecting the operation of a network element, such as an access node, for example a gNB, as shown in the flow chart of FIG. 6, wherein the network element comprises means for providing a first cell being a dynamic spectrum sharing cell supporting at least a first radio access technology, wherein at least one random access preamble indicating a request to be redirected to a second cell supporting at least a second radio access technology is stored in the network element, wherein the method comprises transmitting (600) signaling information to the user equipment, wherein said signaling information comprises information for establishing a connection to the second cell supporting at least the second radio access technology; receiving (602) a random access preamble from the user equipment via the first radio access technology, said random access preamble indicating a request for the user equipment to be redirected to the second cell supporting at least the second radio access technology; transmitting (604) an indication to the second cell to transition to an active state; and transmitting (606) a random access preamble response to the user equipment via the first radio access technology, wherein the random access preamble response comprises signaling for re-directing the user equipment to camp on the second cell supporting at least the second radio access technology.

In the following, the methods and the related embodiments are described for illustrative and simplifying purposes by referring to the 5G/NR RAT as the first radio access technology and the 6G RAT as the second radio access technology. It is, however, noted that the methods and the related embodiments are not limited to dynamic spectrum sharing between 5G and 6G RATs, but they can be applied between any RATs, such as 4G and 6G RATs. Herein, the terms “first cell supporting the first radio access technology” or “5G DSS Cell” and “second cell supporting the second radio access technology” or “6G DSS Cell”, correspondingly, are used to refer to the different radio interfaces and the control protocols of different RATs. However, as mentioned above, in a typical DSS scenario, the 5G DSS Cell and the 6G DSS Cell may share a common radio unit. The same, or alternatively different, baseband units may be used for the 5G DSS Cell and the 6G DSS Cell.

Thus, the methods and the related embodiments enable a 5G-6G DSS to be carried out with significantly reduced overhead and in an energy efficient manner, wherein the 6G DSS cell transmits downlink (DL) signals (including synchronization and MIB) only when there are connected user equipment, or at least have been connected user equipment in a recent period of time on the 6G DSS Cell. Otherwise, the 5G DSS cell advertises the existence of a 6G DSS cell and provides the UE, e.g. via the 5G System Information messages, with minimum System Information needed to camp on the 6G cell. Upon the transition of the UE to RRC connected mode, the 5G cell redirects 6G-capable UEs to the 6G DSS Cell, for example by employing the random access preamble response (RAR) message. The 5G DSS cell transmits an indication to the 6G DSS Cell to transition to an active state so as to enable to carry out the necessary signaling for transition the 6G-capable UEs into a connected mode of the 6G RRC. It is noted that redirecting the UE to 6G DSS Cell via RAR can be enabled, because most of the information on the 6G DSS Cell configuration may be conveyed via the System Information messages and hence the size of the MAC Control Element (MAC CE) for the RAR remains moderate.

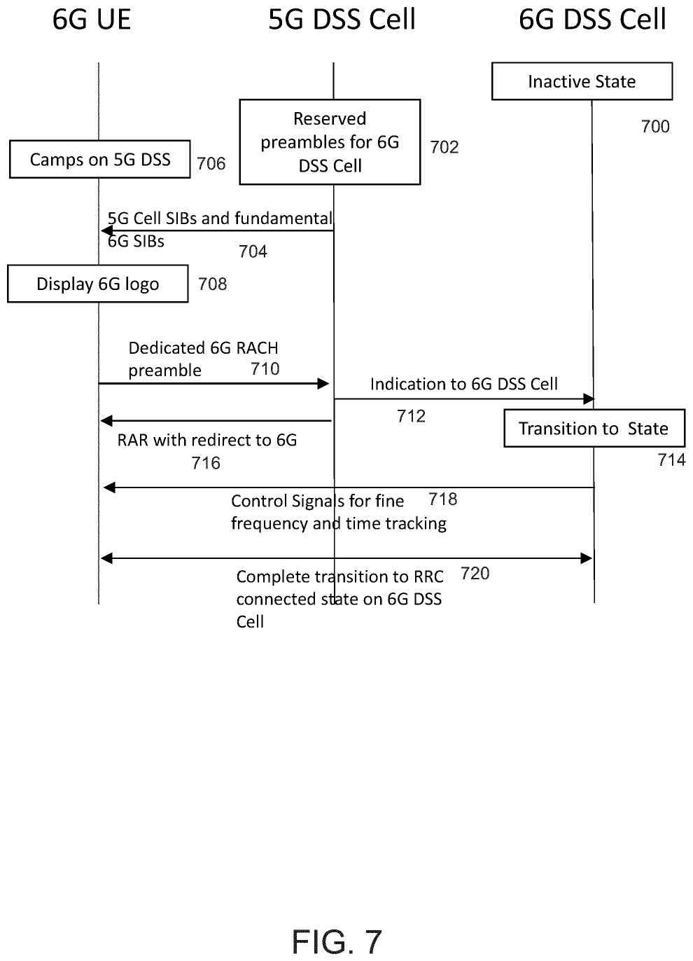

A signalling chart of FIG. 7 shows an exemplifying high-level description about the methods and some of the related embodiments between a 6G UE, a 5G DSS Cell and a 6G DSS Cell. Herein, it is assumed that the UE is registered with the 5G core and the 6G core, and the 6G core is aware of the DSS cell and status: i.e. either active, i.e., DSS cell can transmit Paging resources, or inactive. The 6G core network also may forward paging messages to both 5G and 6G cells, e.g., for high priority paging.

In the beginning, the 6G DSS Cell remains in an inactive state (700). Thus, the 6G DSS cell initially reserves no DL resources for 6G, e.g. no PSS/SSS or MIB/SIB transmissions are carried out. The 5G DSS Cell, as a part of its DSS operation, reserves some RACH preamble resources for 6G UEs (702). It is noted that no other 6G UL resources need to be reserved.

Since the 6G DSS Cell is in the inactive state, the 5G DSS Cell advertises the existence of 6G DSS Cell. Thus, the 5G DSS Cell provides broadcast information to UEs (704), which comprises at least minimum information required to establish an RRC connection with the 6G DSS Cell. The 5G DSS Cell broadcast information may include information on dedicated RACH preambles for the 6G DSS cell, which may share the same RACH occasion as the 5G DSS Cell. The broadcast information may also include, for example, a 6G Cell MIB, which may indicate the status of the 6G DSS Cell, so the UE does not have to continuously monitor via synchronization signals if the 6G DSS cell is active. Thus, the power consumption of the UE is reduced, resulting in battery life savings.

At some point, a 6G capable UE camps on the 5G DSS cell in 5G RRC Idle mode (706). Based on the 5G DSS Cell broadcast information, the UE identifies the cell as a DSS cell.

According to an embodiment, the apparatus, such as the UE, comprises means, responsive to identifying said cell as a dynamic spectrum sharing cell, for displaying a first indication on a display of the apparatus, said first indication indicating that a connection to the second cell supporting at least the second radio access technology is available.

Thus, the UE may display a first type of a 6G icon or any other kind of indication on its display (708), showing to the user that 6G connections are possible in this cell. The UE may then, e.g. as a default setting or deliberate choice of the user, start preparations for establishing a connection to the 6G DSS Cell. Hence, among the RACH preambles received in the 5G DSS Cell broadcast information, the UE selects at least one RACH preamble dedicated for the 6G DSS cell and sends it to the 5G DSS Cell (710). When the 5G DSS cell detects a preamble that was dedicated for the 6G DSS Cell, the 5G DSS cell informs the 6G DSS cell that it needs to transition to the active mode (712). Then the 6G DSS cell transitions to the active mode (714) and starts the preparations for reserving 6G DL/UL resources. The 5G DSS cell responds to the RACH preamble dedicated for the 6G DSS cell received from the UE with a random access preamble response (RAR) message (716).

According to an embodiment, the network element, such as the gNB, comprises means for including in the random access preamble response (RAR) message one or more of the following:
information for re-directing the UE to the second cell;
assistance information on uplink timing information for the UE;
assistance information on downlink timing;
information on aperiodic or periodic signal for fine tuning of a frequency/time of the second cell;
information on a beam of the second cell relative to a beam of the first cell;
a grant for uplink transmission in the second cell.

Thus, the RAR message may additionally include information to help the UE to acquire faster DL synchronization and beam acquisition with the 6G DSS Cell. The uplink timing information for the UE may comprise e.g. the UL timing advance to the 6G DSS Cell. The assistance information on downlink timing may comprise e.g. an offset between 5G and 6G cell timing.

After the 6G DSS cell transitioning to the active mode (714), the 6G DL/UL resources are reserved and transmitted as needed on the 6G DSS cell (718). Herein, the 6G DSS Cell may transmit control signals to the UE for performing fine tuning of time and frequency on the 6G cell based on the previously sent aperiodic or periodic signal.

According to an embodiment, the apparatus, such as the UE, comprises means for performing downlink coarse time and frequency tracking for the second cell based on signals of the first cell. Thus, the UE may perform DL coarse time and frequency tracking for the 6G cell based on 5G cell signals (e.g. SSB or other Reference Symbols).

After having obtained sufficient information, the UE completes the RRC establishment procedure and enters in the connected mode in the 6G DSS cell (720).

According to an embodiment, the apparatus, such as the UE, comprises means, responsive to entering the second cell in a connected mode, for displaying a second indication on the display of the apparatus, said second indication indicating that a connection to the second cell supporting at least the second radio access technology has been established.

Thus, the UE may display a second type of a 6G icon or any other kind of indication on its display, which indicates that the UE is now using the 6G connection.

According to an embodiment, the apparatus, such as the UE, comprises means for transitioning from the connected mode to the idle mode; means for performing measurements for the second cell; and means, responsive to detecting that the second cell is out of coverage, for re-directing the connection to the first cell.

Thus, at some point the UE may not have a need to maintain in the RRC connected mode and it transitions to the RRC idle mode. Nevertheless, the UE in the idle mode on a 6G DSS cell will perform measurements of the cell and monitor for paging as per normal idle mode procedures. If the UE measurements show the 6G DSS cell is out of coverage, the UE falls back to the 5G DSS cell.

According to an embodiment, the apparatus, such as the UE, comprises means for performing inter-radio access technology (I-RAT) measurements among a plurality of cells supporting at least the first and/or the second radio access technology; means for detecting a need for a handover; and means, responsive to detecting that a target cell of the handover supporting the second radio access technology is in an inactive state, for re-directing the connection to a dynamic spectrum sharing cell corresponding to said target cell and using the first radio access technology.

The procedure for UE mobility can also be employed such that the 6G DSS neighbour cells can remain in an inactive state (no DL transmissions). The UE may perform I-RAT measurements for the neighboring 6G DSS cells, and when it notices that a target 6G DSS cell for the handover is in an inactive state, it seeks the corresponding 5G DSS cell and starts the above procedure so as to wake-up the target cell into the active state. Upon all 6G UEs exiting a 6G DSS cell and not having any RRC transactions for a configured period of time, the 6G DSS cell may return to the inactive state.

The operation of an access node, such as a gNB, may also be evaluated from the viewpoint of providing the 6G DSS Cell operations. As mentioned above, in a typical DSS scenario, the same network element, such as an access point, i.e. a gNB, may provide the radio resources for the 5G DSS Cell and the 6G DSS Cell.

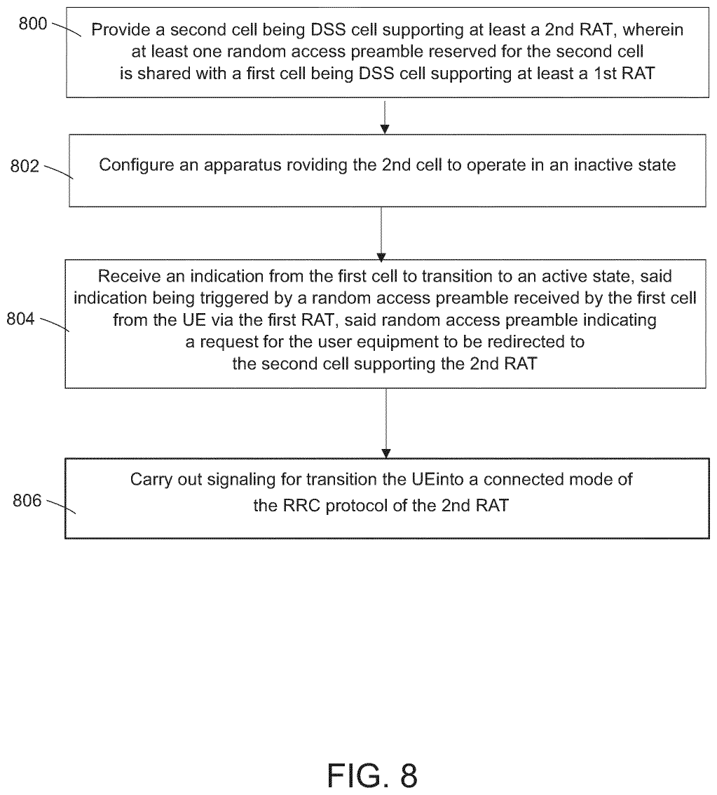

The method may be illustrated as reflecting the operation of a network element, such as an access node, for example a gNB, as shown in the flow chart of FIG. 8, wherein the method comprises providing (800), by a network element, a second cell being a dynamic spectrum sharing cell supporting at least a second radio access technology, wherein at least one random access preamble for said network element in a first cell providing a dynamic spectrum sharing cell supporting at least a first radio access technology indicates a request for a user equipment to be redirected; configuring (802) the network element to operate in an inactive state; receiving (804) an indication from the first cell to transition to an active state, said indication being triggered by a random access preamble received by the first cell from at least one user equipment via the first radio access technology, said random access preamble indicating a request for the user equipment to be redirected to the second cell supporting at least the second radio access technology; and carrying out (806) signaling for transition the user equipment into a connected mode of the radio resource control (RRC) protocol of the second radio access technology.

The methods and the related embodiments may provide significant advantages. A larger number of frequency bands may be allocated to DSS without the risk of increasing the overhead. Since no additional downlink signals (6G Control signals) are transmitted by the 6G DSS Cell when no 6G UEs are in its area, but instead the legacy RAT (e.g. 5G) resources are used efficiently, savings in power consumption of the 6G DSS Cell network elements as well as the 6G UE can be achieved. Moreover, this also contributes to reduced interference in the system, which is particularly important for dense deployments where most the operator traffic is located. On the other hand, timer based 6G DSS cell activation allows for 6G DSS cells to be active longer in areas where lower latency or RRC inactive UEs are to be supported.

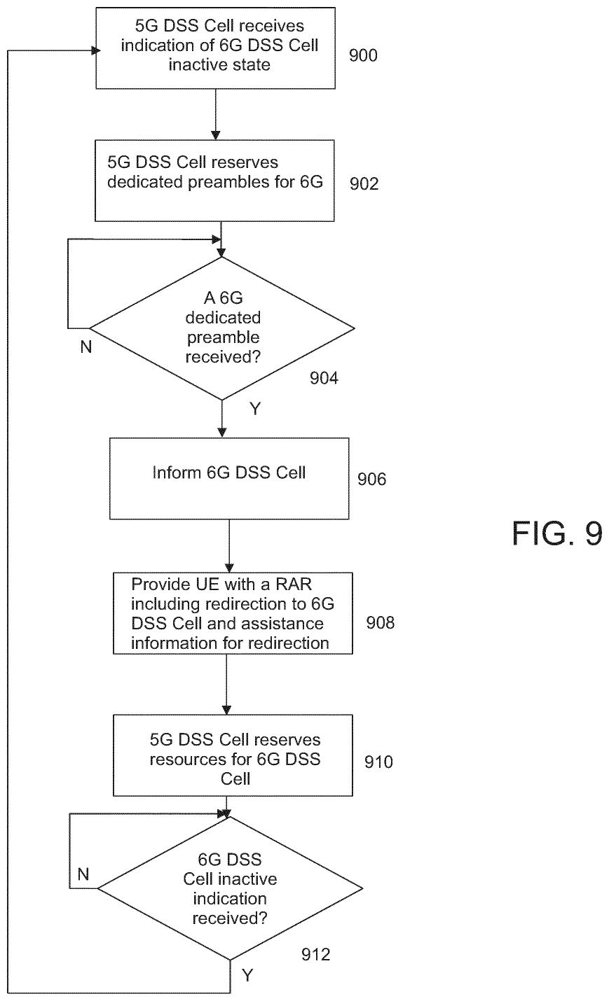

Some of the above embodiments relating to the operation of the cell supporting at least the first radio access technology (i.e. the 5G DSS Cell in this example) are illustrated in the flow chart of FIG. 9.

The 5G DSS cell receives an indication that the 6G DSS cell in is inactive state (900), i.e., the 6G DSS cell does not transmit any DL control signals and only requires the reservation of some RACH resources in the UL. The 5G DSS cell reserves one or more RACH preambles to be dedicated for the 6G DSS cell (902), which are broadcast by the 5G DSS cell to UEs in its area. The RACH resources reserved for the 6G DSS cell may share the same RACH occasion as the 5G DSS Cell. If the 5G DSS cell detects a preamble that was dedicated for the 6G DSS Cell sent by a UE (904), the 5G DSS cell informs the 6G DSS cell that it needs to transition to active mode (906). The 5G DSS cell also responds to the 6G UE's RACH preamble with a RAR message (908), which may include information for re-directing the UE to the 6G DSS cell, as well as various items of assistance information, as described above, for assisting the UE to acquire faster DL synchronization and beam acquisition with the 6G DSS Cell. Upon the 6G DSS cell initiating transition to the active mode, the 5G DSS cell may be instructed to reserve UL and DL resources for 6G DSS Cell (910). If the 5G DSS cell receives a notification from the 6G DSS cell that it has transitioned to inactive state (912), the 5G DSS cell may release any 6G DSS resources reserved for the 6G DSS cell in active state and proceed to only reserve resources required for the 6G DSS cell inactive state (900).

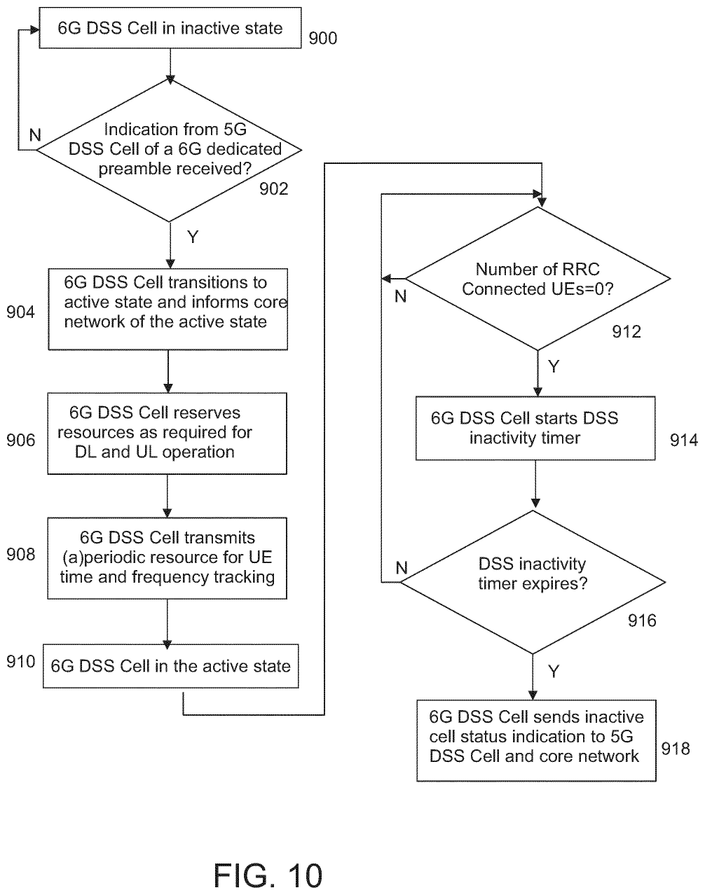

Some of the above embodiments relating to the operation of the cell supporting at least the second radio access technology (i.e. the 6G DSS Cell in this example) are illustrated in the flow chart of FIG. 10.

Again, the 6G DSS cell is in initially in an inactive state (1000) and the core network and other neighbour 6G/5G cells are informed of this state. If the 6G DSS cell receives an indication from the 5G DSS cell that the 5G DSS cell has detected a preamble dedicated for the 6G DSS Cell sent by a UE (1002), the 6G DSS Cell initiates its transitions to an active state (1004).

It is noted that the indication from the 5G DSS cell may also include additional information on the UE triggering the transition to the active state, such as:
Information on the UE capabilities for handover scenarios;
Beam related information of the 5G DSS cell, e.g. UL beam used for the RACH procedure;
Timing advance information provided to the UE by the 5G DSS cell;
Information on the type of RACH triggered by the 6G UE in the 5G DSS Cell. If RACH resources are further portioned for different slices or services or UE capabilities, this information may be employed by the 6G DSS cell to appropriately handle the UE;
Information on the periodic or aperiodic frequency/timing fine tuning information provided to the UE;
Information on the UL grant the UE will be using to continue with the RRC connection procedure. It is noted the 6G DSS cell may alternatively decide to provide an UL grant via a separate DL transmission in the 6G DSS Cell after the UE has acquired synchronization with the 6G DSS Cell.

The 6G DSS cell may also inform the core network that it has transitioned to an active state (1004) for the core network to be able to page the UE in the correct RAT. Other neighbouring 5G and 6G cells may also be informed of the transition of the 6G DSS cell to active state for mobility purposes. During the transition period to active state the 6G DSS cell will reserve resources for UL and DL (1006). This may include at least resources for control signalling in the UL and the DL. The 6G DSS cell may transmit specific aperiodic or periodic control signals (1008) to enable faster UE synchronization to the 6G DSS cell. Once the 6G DSS cell enters active state (1010), it proceeds as per 6G procedures.

The 6G DSS cell may continuously monitor the number of UEs in RRC connected mode in 6G DSS cell. Once there are no remaining UEs in RRC connected mode in the 6G DSS cell (1012), the 6G DSS cell may start an inactivity timer (1014). The parameters for the timer may be defined via O&M parameters or set via a machine learning algorithm. Upon the expiration of the timer (1016), the 6G DSS Cell may transition back to an inactive state (1018).

It is noted that for mobility purposes within 6G, the 6G UE may be instructed to perform I-RAT measurements of a 5G DSS cell with a 6G DSS reserved preamble, as described above. Therefore, the RACH and the RAR for the handover procedure may be performed on the 5G DSS cell in the same manner as the RRC idle to RRC connected mode transition explained in the above.

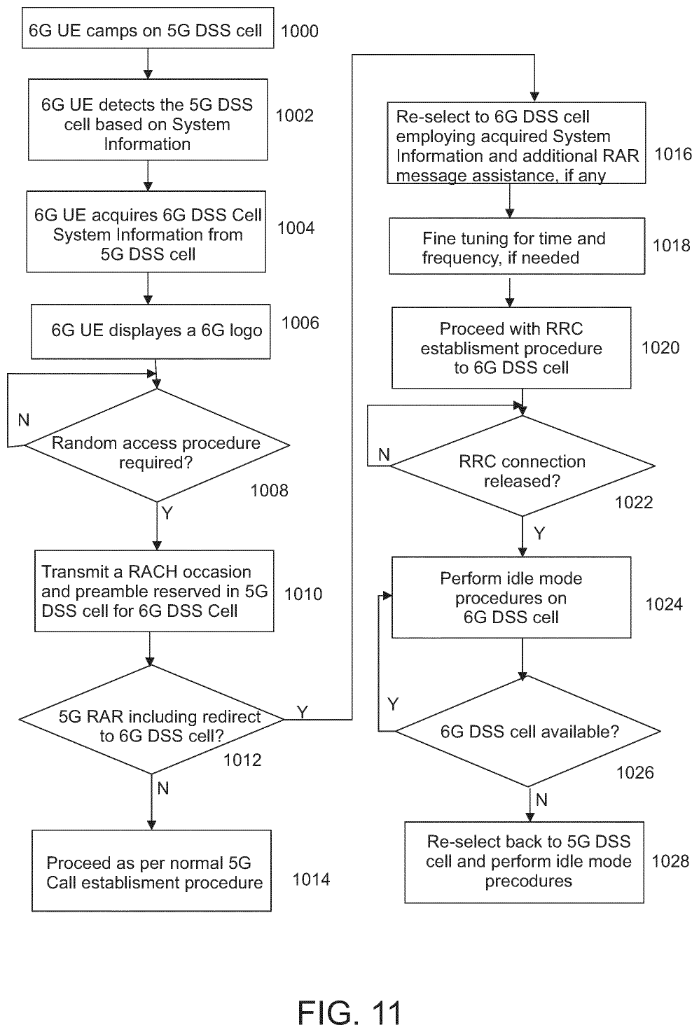

Some of the above embodiments relating to the operation of the 6G UE are illustrated in the flow chart of FIG. 11.

Again, it is assumed that the 6G DSS cell is in inactive state, hence the UE scans and selects the 5G DSS Cell (1100). Upon acquisition of the 5G DSS cell System information messages, the UE learns that the 5G Cell is a DSS cell and it shares resources with a 6G cell (1102). The UE also acquires the minimum system Information required to establish an RRC connection with the 6G cell (1104). The UE may also display a 6G logo indicating it has access to a 6G RAT (1106). When the UE requires to initiate a random-access procedure (1108), it may decide to employ the 6G dedicated preambles (1110). The 5G DSS cell may respond to the preamble with a conventional 5G RAR message (1112), whereupon the UE proceeds with a RRC establishment procedure in the 5G DSS cell (1114).

If the 5G DSS cell responds to the preamble with a redirection to the 6G DSS cell (1112), the UE shall employ the information acquired via the SIB to continue the RRC establishment procedure in the 6G DSS cell (1116). The UE may need to perform fine frequency and time acquisition of the 6G DSS cell (1118) prior to proceeding with completing the RRC establishment procedure (1120). Once the RRC connection of the UE is released (1122), the UE may receive information on the 6G DSS Cell inactivity timer, such as an estimate on the minimum time the 6G DSS cell may remain in active state. The UE may perform idle mode procedures on the 6G DSS cell while it is in active state (1124). Upon the 6G DSS cell entering the inactive state (1126), the UE shall revert to the corresponding 5G DSS cell (1128).

An apparatus, such as a UE, according to an aspect comprises means for establishing a connection to a cell using a first radio access technology and a second radio access technology; means for camping on a first cell using at least the first radio access technology in an idle mode of radio resource control (RRC) protocol of the first radio access technology; means for identifying, in response to receiving signaling information from the first cell, said first cell as a dynamic spectrum sharing cell, wherein spectrum sharing provides support for a second cell supporting the second radio access technology and said signaling information comprises information for establishing a connection to the second cell; means for transmitting a random access preamble to the first cell, said random access preamble indicating a request to be redirected to the second cell supporting the second radio access technology; means for receiving a random access preamble response from the first cell; means for redirecting, based on the random access preamble response, to the second cell supporting the second radio access technology; and means for carrying out signaling for transition the apparatus into a connected mode of the radio resource control (RRC) protocol of the second radio access technology.

According to an embodiment, the random access preamble is a random access preamble dedicated to the second cell supporting the second radio access technology.

According to an embodiment, the apparatus comprises means for performing downlink coarse time and frequency tracking for the second cell based on signals of the first cell.

According to an embodiment, the apparatus comprises means for transitioning from the connected mode to the idle mode; means for performing measurements for the second cell; and means, responsive to detecting that the second cell is out of coverage, for re-directing the connection to the first cell.

According to an embodiment, the apparatus comprises means for performing inter-radio access technology measurements among a plurality of cells supporting at least the first and the second radio access technology; means for detecting a need for a handover; and means, responsive to detecting that a target cell of the handover supporting the second radio access technology is in an inactive state, for re-directing the connection to a dynamic spectrum sharing cell corresponding to said target cell and using said measurements on the first radio access technology.

According to an embodiment, the apparatus comprises means, responsive to identifying said cell as a dynamic spectrum sharing cell, for displaying a first indication on a display of the apparatus, said first indication indicating that a connection to the second cell supporting at least the second radio access technology is available.

According to an embodiment, the apparatus comprises means, responsive to entering the second cell in a connected mode, for displaying a second indication on the display of the apparatus, said second indication indicating that a connection to the second cell supporting at least the second radio access technology has been established.

According to an embodiment, said signaling information comprises information on service-based usage of the random access preambles associated with the first radio access technology and the second radio access technology.

According to an embodiment, the apparatus comprises means for selecting a preamble from the first or the second radio access technology based on a type of service that is being initiated.

According to an embodiment, the random access preamble response comprises timing advance information and downlink timing received from the first cell using the first radio access technology, the apparatus comprising means for employing the timing advance information and the downlink timing of the first cell using the first radio access technology to synchronize downlink and uplink of the second cell using the second radio access technology. According to an embodiment, the apparatus comprises means for obtaining non-essential system information after redirecting to the second cell using the second radio access technology.

An apparatus according to a further aspect comprises at least one processor and at least one memory, said at least one memory stored with computer program code thereon, the at least one memory and the computer program code configured to, with the at least one processor, cause the apparatus at least to perform: camp on a first cell using at least the first radio access technology in an idle mode of radio resource control (RRC) protocol of the first radio access technology; identify, in response to receiving signaling information from the first cell, said first cell as a dynamic spectrum sharing cell, wherein spectrum sharing provides support for a second cell supporting the second radio access technology and said signaling information comprises information for establishing a connection to the second cell; transmit a random access preamble to the first cell, said random access preamble indicating a request to be redirected to the second cell supporting the second radio access technology; receive a random access preamble response from the first cell; redirect, based on the random access preamble response, to the second cell supporting the second radio access technology; and carry out signaling for transition the apparatus into a connected mode of the radio resource control (RRC) protocol of the second radio access technology.

Such apparatuses may comprise e.g. apparatuses and/or the functional units disclosed in any of the FIGS. 1-4 and 7 for implementing the embodiments.

A further aspect relates to a computer program product, stored on a non-transitory memory medium, comprising computer program code, which when executed by at least one processor, causes an apparatus at least to perform: camp on a first cell using at least the first radio access technology in an idle mode of radio resource control (RRC) protocol of the first radio access technology; identify, in response to receiving signaling information from the first cell, said first cell as a dynamic spectrum sharing cell, wherein spectrum sharing provides support for a second cell supporting the second radio access technology and said signaling information comprises information for establishing a connection to the second cell; transmit a random access preamble to the first cell, said random access preamble indicating a request to be redirected to the second cell supporting the second radio access technology; receive a random access preamble response from the first cell; redirect, based on the random access preamble response, to the second cell supporting the second radio access technology; and carry out signaling for transition the apparatus into a connected mode of the radio resource control (RRC) protocol of the second radio access technology.

Another aspect relates to an apparatus providing the 5G DDS Cell, such as an access node, e.g. a gNB. Such as an apparatus may comprise means for providing a first cell being a dynamic spectrum sharing cell supporting at least a first radio access technology, wherein at least one random access preamble indicating a request to be redirected to a second cell supporting at least a second radio access technology is stored in the apparatus; means for transmitting signaling information to at least one user equipment via the first radio access technology, wherein said signaling information comprises information for establishing a connection to the second cell; means for receiving a random access preamble from at least one user equipment via the first radio access technology, said random access preamble indicating a request for the user equipment to be redirected to the second cell supporting at least the second radio access technology; means for transmitting an indication to the second cell to transition to an active state; and means for transmitting a random access preamble response to the user equipment via the first radio access technology, wherein the random access preamble response comprises signaling for re-directing the user equipment to camp on a second cell supporting at least the second radio access technology.

According to an embodiment, the random access preamble is a random access preamble dedicated to the second cell supporting the second radio access technology.

According to an embodiment, the apparatus comprises means comprises means for including in the random access preamble response (RAR) message one or more of the following:
information for re-directing the user equipment to the second cell;
assistance information on uplink timing information to the second cell for the user equipment;
assistance information on downlink timing;
information on aperiodic or periodic signal for fine tuning of a frequency/time of the second cell;
information on a beam of the second cell relative to a beam of the first cell;
a grant for uplink transmission in the second cell.

According to an embodiment, said signaling information comprises information on service-based usage of the random access preambles associated with the first radio access technology and the second radio access technology.

According to an embodiment, the apparatus comprises means for configuring the user equipment to perform inter-radio access technology measurements for an intra-radio access technology handover of a target dynamic spectrum sharing cell in which the second radio access technology is inactive.

Such an apparatus may also comprise at least one processor and at least one memory, said at least one memory stored with computer program code thereon, the at least one memory and the computer program code configured to, with the at least one processor, cause the apparatus at least to perform: provide a first cell being a dynamic spectrum sharing cell supporting at least a first radio access technology, wherein at least one random access preamble indicating a request to be redirected to a second cell supporting at least a second radio access technology is stored in the apparatus; transmit signaling information to at least one user equipment via the first radio access technology, wherein said signaling information comprises information for establishing a connection to the second cell; receive a random access preamble from at least one user equipment via the first radio access technology, said random access preamble indicating a request for the user equipment to be redirected to the second cell supporting at least the second radio access technology; transmit an indication to the second cell to transition to an active state; and transmit a random access preamble response to the user equipment via the first radio access technology, wherein the random access preamble response comprises signaling for re-directing the user equipment to camp on a second cell supporting at least the second radio access technology.

A further aspect relates to a computer program product, stored on a non-transitory memory medium, comprising computer program code, which when executed by at least one processor, causes an apparatus at least to perform: provide a first cell being a dynamic spectrum sharing cell supporting at least a first radio access technology, wherein at least one random access preamble indicating a request to be redirected to a second cell supporting at least a second radio access technology is stored in the apparatus; transmit signaling information to at least one user equipment via the first radio access technology, wherein said signaling information comprises information for establishing a connection to the second cell; receive a random access preamble from at least one user equipment via the first radio access technology, said random access preamble indicating a request for the user equipment to be redirected to the second cell supporting at least the second radio access technology; transmit an indication to the second cell to transition to an active state; and transmit a random access preamble response to the user equipment via the first radio access technology, wherein the random access preamble response comprises signaling for re-directing the user equipment to camp on a second cell supporting at least the second radio access technology.

Yet aspect relates to an apparatus providing the 6G DDS Cell, such as an access node, e.g. a gNB. Such as an apparatus may comprise means for means for providing a second cell being a dynamic spectrum sharing cell supporting at least a second radio access technology, wherein at least one random access preamble for said apparatus in a first cell providing a dynamic spectrum sharing cell supporting at least a first radio access technology indicates a request for a user equipment to be redirected; means for configuring the apparatus to operate in an inactive state; means for receiving an indication from the first cell to transition to an active state, said indication being triggered by a random access preamble received by the first cell from at least one user equipment via the first radio access technology, said random access preamble indicating a request for the user equipment to be redirected to the second cell supporting at least the second radio access technology; and means for carrying out signaling for transition the user equipment into a connected mode of the radio resource control (RRC) protocol of the second radio access technology.

According to an embodiment, the random access preamble is a random access preamble dedicated to the second cell supporting the second radio access technology.

According to an embodiment, the apparatus comprises means for transmitting downlink broadcast and control information to the user equipment in the active state.

According to an embodiment, the apparatus comprises means for initiating a timer when the number of the user equipment in the connected mode of the RRC protocol is zero; and means for configuring the apparatus to transition to an inactive state upon expiry of the timer.

According to an embodiment, the apparatus comprises means for ceasing to transmit downlink broadcast and control information to the user equipment in the active state.

According to an embodiment, the apparatus comprises means for informing the a core network of the transition to the inactive state.

According to an embodiment, the apparatus comprises means for informing other cells using the second radio access technology about the transition to the inactive state.

Such an apparatus may also comprise at least one processor and at least one memory, said at least one memory stored with computer program code thereon, the at least one memory and the computer program code configured to, with the at least one processor, cause the apparatus at least to perform: provide a second cell being a dynamic spectrum sharing cell supporting at least a second radio access technology, wherein at least one random access preamble for said apparatus in a first cell providing a dynamic spectrum sharing cell supporting at least a first radio access technology indicates a request for a user equipment to be redirected; configure the apparatus to operate in an inactive state; receive an indication from the first cell to transition to an active state, said indication being triggered by a random access preamble received by the first cell from at least one user equipment via the first radio access technology, said random access preamble indicating a request for the user equipment to be redirected to the second cell supporting at least the second radio access technology; and carry out signaling for transition the user equipment into a connected mode of the radio resource control (RRC) protocol of the second radio access technology.

A further aspect relates to a computer program product, stored on a non-transitory memory medium, comprising computer program code, which when executed by at least one processor, causes an apparatus at least to perform: provide a second cell being a dynamic spectrum sharing cell supporting at least a second radio access technology, wherein at least one random access preamble for said apparatus in a first cell providing a dynamic spectrum sharing cell supporting at least a first radio access technology indicates a request for a user equipment to be redirected; configure the apparatus to operate in an inactive state; receive an indication from the first cell to transition to an active state, said indication being triggered by a random access preamble received by the first cell from at least one user equipment via the first radio access technology, said random access preamble indicating a request for the user equipment to be redirected to the second cell supporting at least the second radio access technology; and carry out signaling for transition the user equipment into a connected mode of the radio resource control (RRC) protocol of the second radio access technology.

In general, the various embodiments of the invention may be implemented in hardware or special purpose circuits or any combination thereof. While various aspects of the invention may be illustrated and described as block diagrams or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended examples. However, all such and similar modifications of the teachings of this invention will still fall within the scope of this invention.

1-32. (canceled)

33. An apparatus comprising at least one processor and at least one memory, said at least one memory stored with computer program code thereon, the at least one memory and the computer program code configured to, with the at least one processor, cause the apparatus at least to:
establish a connection to a cell using a first radio access technology and a second radio access technology;
camp on a first cell using at least the first radio access technology in an idle mode of radio resource control (RRC) protocol of the first radio access technology;
identify, in response to receiving signaling information from the first cell, said first cell as a dynamic spectrum sharing cell, wherein spectrum sharing provides support for a second cell supporting the second radio access technology and said signaling information comprises information for establishing a connection to the second cell;
transmit a random access preamble to the first cell, said random access preamble indicating a request to be redirected to the second cell supporting the second radio access technology;
receive a random access preamble response from the first cell;
redirect, based on the random access preamble response, to the second cell supporting the second radio access technology; and
carry out signaling for transition the apparatus into a connected mode of the radio resource control (RRC) protocol of the second radio access technology.

34. The apparatus according to claim 33, wherein the random access preamble is a random access preamble dedicated to the second cell supporting the second radio access technology.

35. The apparatus according to claim 33, further being caused to perform downlink coarse time and frequency tracking for the second cell based on signals of the first cell.

36. The apparatus according to claim 33, further being caused to transition from the connected mode to the idle mode;
perform measurements for the second cell; and
responsive to detecting that the second cell is out of coverage, re-direct the connection to the first cell.

37. The apparatus according to claim 33, further being caused to perform inter-radio access technology measurements among a plurality of cells supporting at least the first and the second radio access technology;
detect a need for a handover; and
responsive to detecting that a target cell of the handover supporting the second radio access technology is in an inactive state, re-direct the connection to a dynamic spectrum sharing cell corresponding to said target cell and using said measurements on the first radio access technology.

38. The apparatus according to claim 33, further being caused to, responsive to identifying said cell as a dynamic spectrum sharing cell, display a first indication on a display of the apparatus, said first indication indicating that a connection to the second cell supporting at least the second radio access technology is available.

39. The apparatus according to claim 33, further being caused to, responsive to entering the second cell in a connected mode, display a second indication on the display of the apparatus, said second indication indicating that a connection to the second cell supporting at least the second radio access technology has been established.

40. The apparatus according to claim 33, wherein said signaling information comprises information on service-based usage of the random access preambles associated with the first radio access technology and the second radio access technology.

41. The apparatus according to claim 33, wherein said signaling information comprises information on service-based usage of the random access preambles associated with the first radio access technology and the second radio access technology, the apparatus further being caused to select a preamble from the first or the second radio access technology based on a type of service that is being initiated.

42. The apparatus according to claim 33, wherein the random access preamble response comprises timing advance information and downlink timing received from the first cell using the first radio access technology, the apparatus further being caused to employ the timing advance information and the downlink timing of the first cell using the first radio access technology to synchronize downlink and uplink of the second cell using the second radio access technology.

43. The apparatus according to claim 33, the apparatus being caused to obtain non-essential system information after redirecting to the second cell using the second radio access technology.

44. An apparatus comprising at least one processor and at least one memory, said at least one memory stored with computer program code thereon, the at least one memory and the computer program code configured to, with the at least one processor, cause the apparatus at least to:
provide a first cell being a dynamic spectrum sharing cell supporting at least a first radio access technology, wherein at least one random access preamble indicating a request to be redirected to a second cell supporting at least a second radio access technology is stored in the apparatus;
transmit signaling information to at least one user equipment via the first radio access technology, wherein said signaling information comprises information for establishing a connection to the second cell;
receive a random access preamble from at least one user equipment via the first radio access technology, said random access preamble indicating a request for the user equipment to be redirected to the second cell supporting at least the second radio access technology;
transmit an indication to the second cell to transition to an active state; and
transmit a random access preamble response to the user equipment via the first radio access technology, wherein the random access preamble response comprises signaling for re-directing the user equipment to camp on a second cell supporting at least the second radio access technology.

45. The apparatus according to claim 44, wherein the random access preamble is a random access preamble dedicated to the second cell supporting the second radio access technology.

46. The apparatus according to claim 44, further being caused to include in the random access preamble response (RAR) message one or more of the following:
information for re-directing the user equipment to the second cell;
assistance information on uplink timing information to the second cell for the user equipment;
assistance information on downlink timing;
information on aperiodic or periodic signal for fine tuning of a frequency/time of the second cell;
information on a beam of the second cell relative to a beam of the first cell;
a grant for uplink transmission in the second cell.

47. The apparatus according to claim 44, said signaling information comprises information on service-based usage of the random access preambles associated with the first radio access technology and the second radio access technology.

48. The apparatus according to claim 44, further being caused to configure the user equipment to perform inter-radio access technology measurements for an intra-radio access technology handover of a target dynamic spectrum sharing cell in which the second radio access technology is inactive.

49. An apparatus comprising: at least one processor and at least one memory, said at least one memory stored with computer program code thereon, the at least one memory and the computer program code configured to, with the at least one processor, cause the apparatus at least to:
provide a second cell being a dynamic spectrum sharing cell supporting at least a second radio access technology, wherein at least one random access preamble for said apparatus in a first cell providing a dynamic spectrum sharing cell supporting at least a first radio access technology indicates a request for a user equipment to be redirected;
configure the apparatus to operate in an inactive state;
receive an indication from the first cell to transition to an active state, said indication being triggered by a random access preamble received by the first cell from at least one user equipment via the first radio access technology, said random access preamble indicating a request for the user equipment to be redirected to the second cell supporting at least the second radio access technology; and
carry out signaling for transition the user equipment into a connected mode of the radio resource control (RRC) protocol of the second radio access technology.

50. The apparatus according to claim 17, wherein the random access preamble is a random access preamble dedicated to the second cell supporting the second radio access technology.

51. The apparatus according to claim 49, further being caused to transmit downlink broadcast and control information to the user equipment in the active state.

52. The apparatus according to claim 49, further being caused to initiate a timer when the number of the user equipment in the connected mode of the RRC protocol is zero; and
configure the apparatus to transition to an inactive state upon expiry of the timer.

53. The apparatus according to claim 49, further being caused to initiate a timer when the number of the user equipment in the connected mode of the RRC protocol is zero;
configure the apparatus to transition to an inactive state upon expiry of the timer, and cease to transmit downlink broadcast and control information to the user equipment in the active state.

54. The apparatus according to claim 49, further being caused to initiate a timer when the number of the user equipment in the connected mode of the RRC protocol is zero;
configure the apparatus to transition to an inactive state upon expiry of the timer, and inform a core network of the transition to the inactive state.

55. The apparatus according to claim 49, further being caused to initiate a timer when the number of the user equipment in the connected mode of the RRC protocol is zero;
configure the apparatus to transition to an inactive state upon expiry of the timer, and inform other cells using the second radio access technology about the transition to the inactive state.
